(19) United States
(12) Patent Application Publication
(10) Pub. No.: US 2023/0253590 A1
(43) Pub. Date: Aug. 10, 2023

(54) FUEL CELL SYSTEM AND CONTROL METHOD FOR FUEL CELL SYSTEM

(71) Applicant: Mitsubishi Electric Corporation, Tokyo (JP)

(72) Inventors: Takahito IDA, Tokyo (JP); Daigo TAKEMURA, Tokyo (JP)

(73) Assignee: Mitsubishi Electric Corporation, Tokyo (JP)

(21) Appl. No.: 18/012,981

(22) PCT Filed: Aug. 21, 2020
(86) PCT No.: PCT/JP2020/031669

§ 371 Date: Dec. 27, 2022

(51) Int. Cl. H01M 8/04992; H01M 16/00; H01M 10/46; H01M 8/04537; H01M 8/04858; H01M 8/0432; H01M 10/44; H02J 7/34

(52) U.S. Cl. CPC H01M 8/04992; H01M 16/006; H01M 10/46; H01M 8/04604; H01M 8/04925; H01M 8/04365; H01M 10/44; H02J 7/342

(57) ABSTRACT

A fuel cell system includes a fuel cell, a storage battery, a storage battery controller, an electric power demand predictor, and a fuel cell controller. The fuel cell controller calculates a full-charge necessary electric power amount, which is an amount of electric power necessary for fully charging the storage battery, by using a residual capacity and a first time, which is a time that is immediately before a time at which electric power demand becomes maximum among time at which predicted electric power demand and a fuel cell output become equal to each other. The fuel cell controller calculates a fuel cell adjustment output by dividing the full-charge necessary electric power amount by time from a present time to the first time, and controls the fuel cell with the calculated fuel cell adjustment output.

### FIELD

The present disclosure relates to a fuel cell system including a fuel cell and a storage battery, and a control method for the fuel cell system.

### BACKGROUND

In recent years, fuel cell systems have become widespread in order to efficiently supply electric power and heat to homes and the like. The fuel cell system includes a fuel cell and a storage battery, and the system has been generally configured to store an excess amount of electric power in the storage battery when a power generation output of the fuel cell exceeds an electric power load.

In Patent Literature 1, future demand is predicted by learning past electric power demand and past heat demand, and a power generation amount of fuel cell is adjusted such that a total of electric power energy and heat energy is most energy saving with respect to the demand prediction.

### CITATION LIST

### Patent Literature

Patent Literature 1: Japanese Patent Application Laid-open No. 2015-162966

### SUMMARY

### Technical Problem

In Patent Literature 1, the total of the electric power energy and heat energy is controlled to be the most energy-saving, but deterioration of the fuel cell and the storage battery is not considered. In a case of the fuel cell, there is a concern that performance is deteriorated due to deterioration of a catalyst, breakage of a component, or the like due to a large output fluctuation. Whereas, in a case of a storage battery, there is a concern that a storage capacity is deteriorated by being left in a high charge state for a long period of time.

The present disclosure has been made in view of the above, and an object thereof is to provide a fuel cell system and a control method for the fuel cell system, for minimizing deterioration of a fuel cell and a storage battery.

### Solution to Problem

To solve the above problems and achieve the object a fuel cell system according to the present disclosure includes: a fuel cell; a storage battery adapted to store electric power generated by the fuel cell and supply electric power to an electric power load; a storage battery controller adapted to control charging and discharging of the storage battery and acquire a residual capacity of the storage battery; an electric power demand predictor adapted to predict electric power demand of the electric power load; and a fuel cell controller. The fuel cell controller is adapted to calculate a full-charge necessary electric power amount that is an electric power amount necessary for fully charging the storage battery by using a first time being a time that is before a time at which electric power demand becomes maximum and is closest to the time at which electric power demand becomes maximum among times at which the predicted electric power demand and a fuel cell output become equal to each other and the acquired residual capacity. And the fuel cell controller is adapted: to calculate a fuel cell adjustment output by dividing the calculated full-charge necessary electric power amount by time from a present time to the first time; and to control the fuel cell to cause the fuel cell to generate electric power with the calculated fuel cell adjustment output.

### Advantageous Effects of Invention

According to the present disclosure, it is possible to minimize deterioration of a fuel cell and a storage battery.

### BRIEF DESCRIPTION OF DRAWINGS

FIG. 1 is a block diagram illustrating a functional configuration example of a fuel cell system according to a first embodiment.

FIG. 2 is a view illustrating an example of a correspondence table having a relationship between a voltage of a storage battery and an SOC.

FIG. 3 is a flowchart illustrating an example of a processing procedure of the fuel cell system of the first embodiment.

FIG. 4 is a graph illustrating an example of temporal changes of electric power demand, a storage amount, a fuel cell output, and a fuel cell adjustment output of the fuel cell system of the first embodiment.

FIG. 5 is a block diagram illustrating a functional configuration example of a fuel cell system according to a second embodiment.

FIG. 6 is a flowchart illustrating an example of a processing procedure of the fuel cell system of the second embodiment.

FIG. 7 is a block diagram illustrating a functional configuration example of a fuel cell system according to a third embodiment.

FIG. 8 is a flowchart illustrating an example of a processing procedure of the fuel cell system of the third embodiment.

### DESCRIPTION OF EMBODIMENTS

Hereinafter, a fuel cell system and a control method for the fuel cell system according to an embodiment will be described in detail with reference to the drawings.

### First Embodiment

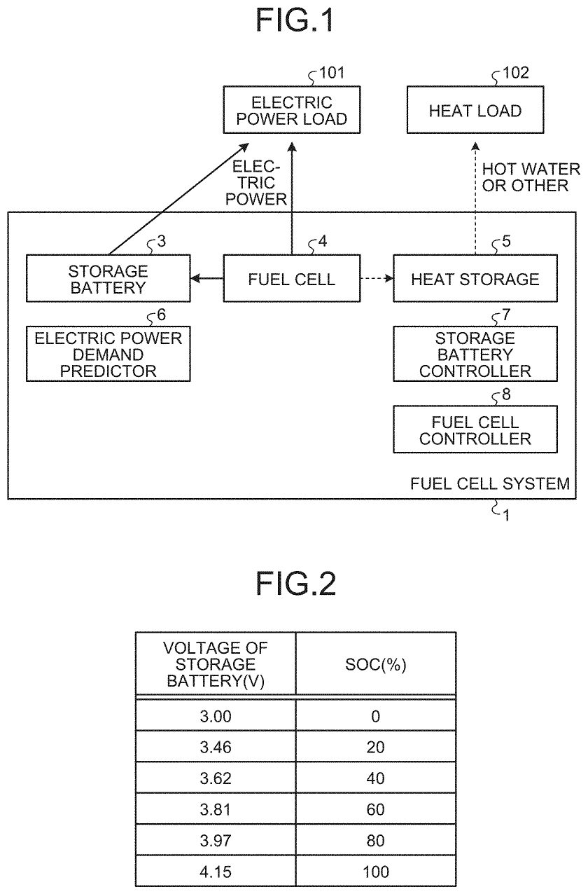

A fuel cell system 1 of a first embodiment will be described with reference to the drawings. FIG. 1 is a block diagram illustrating a functional configuration example of the fuel cell system 1 according to the first embodiment. The fuel cell system 1 includes a storage battery 3, a fuel cell 4, a heat storage 5, an electric power demand predictor 6, a storage battery controller 7, and a fuel cell controller 8, as main components. The fuel cell system 1 is configured to be able to supply electric power to an electric power load 101 and to supply heat to a heat load 102 according to demand.

The storage battery 3 is configured to be able to store (charge) DC power generated by the fuel cell 4. Further, the storage battery 3 is configured to be able to supply electric power stored in the storage battery 3 to the electric power load 101. That is, the storage battery 3 is configured to be able to temporarily store excess electric power exceeding electric power to be supplied to the electric power load 101 in electric power generated by the fuel cell 4, and supply, stored power to the electric power load 101 in a time zone different from a time zone in which the excess electric power is generated. Examples of the storage battery 3 include a lithium ion secondary battery and a nickel hydrogen battery.

The fuel cell 4 is a device that generates electric power by using hydrocarbon such as hydrogen, methane, or propane as fuel. Methane and propane are supplied in a form of city gas or LP gas. Methane, propane, and the like are used by being reformed into gas containing hydrogen as a main component by a reforming reaction. Further, air is supplied to the fuel cell 4 as oxygen-containing gas in the present embodiment, and power generation is performed through a chemical reaction between hydrogen and oxygen to enable DC power to be extracted. Note that supply amounts of fuel and air can be adjusted by a gas flow rate control valve (not illustrated) or the like. As a result, electric power generated from the fuel cell 4 is supplied to the electric power load 101 or the storage battery 3. Further, the chemical reaction between hydrogen and oxygen in the fuel cell 4 is an exothermic reaction, and heat is generated as the reaction proceeds. Therefore, the fuel cell generates electric power and also generates heat. Examples of such a fuel cell 4 include a polymer electrolyte fuel cell (PEFC), a solid oxide fuel cell (SOFC), a molten carbonate fuel cell (MCFC), and a phosphoric acid fuel cell (PAFC).

The heat storage 5 stores heat generated by the fuel cell 4, and supplies heat according to heat demand. The heat mentioned here is, for example, hot water, and the heat storage 5 is, for example, a hot water storage tank. Since the fuel cell 4 generates heat, cooling water is circulated. The cooling water cools the fuel cell 4, and recovers exhaust heat from the fuel cell 4 to heat the cooling water itself. The heated cooling water becomes hot water, and flows into the hot water storage tank as the heat storage 5, to be stored. The heated cooling water may be further heated to a desired temperature by an electric heater or the like as necessary. The heat stored in the form of hot water stored in the heat storage 5 is further supplied to the heat load 102. Between the heat storage 5 and the heat load 102, an auxiliary heater to heat hot water supplied from the heat storage 5 may be disposed. Such an auxiliary heater can be configured to include, for example, a heat exchanger that causes hot water as a heating target to flow, and a burner that heats hot water flowing through the heat exchanger by flame.

As described above, the present embodiment provides a configuration in which heat generated in the fuel cell 4 is recovered in the form of hot water, excess heat exceeding an amount of heat to be supplied to the heat load 102 is stored in the hot water storage tank as the heat storage 5, and hot water stored in the hot water storage tank can be supplied to the heat load. 102 in a time zone different from a time zone in which the excess heat is generated.

The storage battery controller 7 observes a voltage, a current, and a temperature of the storage battery 3, and monitors a state of the storage battery 3. Specifically, the storage battery controller 7 includes: a voltage sensor (not illustrated) for detection of a voltage value between a positive electrode and a negative electrode of the storage battery 3; a current sensor (not illustrated) for detection of a current value when the storage battery 3 is being charged or a current value when the storage battery 3 is being discharged; a temperature sensor (not illustrated) for measurement of a temperature of the storage battery 3; and the like. In addition, the storage battery controller 7 detects a residual capacity of the storage battery 3, in other words, a storage amount. A residual capacity G is obtained by a product of a full-charge capacity (FCC) of the storage battery 3 and a state of charge (SOC) of the storage battery 3. That is, the residual capacity G=FCC×SOC is satisfied.

The SOC is an index of the storage battery 3 in which 0% indicates a discharged state and 100% indicates a fully charged state. Examples of a means for detecting the SOC include a method of estimating the SOC from a voltage of the storage battery 3 and a method of estimating the SOC from integration of charged and discharged current values, but other methods may be used. Here, the method of estimating the SOC from a voltage of the storage battery 3 will be described. The fuel cell controller 8 previously stores a correspondence table indicating a correspondence relationship between a voltage and an SOC of the storage battery 3, and calculates the SOC corresponding to a present voltage of the storage battery 3 by using a measured present voltage of the storage battery 3 and the correspondence table.

FIG. 2 is a view illustrating an example of a correspondence table having a relationship between a voltage of the storage battery 3 and an SOC. FIG. 2 illustrates a part of the relationship between the voltage of the storage battery 3 and the SOC, stored in the correspondence table. For example, when a present voltage of the storage battery 3 is 3.62 V, the SOC is estimated to be 40%.

The residual capacity G of the storage battery 3 is notified to the storage battery controller 7. When the electric power demand E>a power generation output of the fuel cell 4 is satisfied, the storage battery controller 7 discharges the storage battery 3, and supplies electric power of (the electric power demand E−the power generation output of the fuel cell 4) to the electric power load 101. When the electric power demand E<the power generation output of the fuel cell 4 is satisfied, the storage battery 3 is charged with electric power of (the power generation output of the fuel cell 4−the electric power demand E). Further, when determining that the storage battery 3 is in an anomalous state including an overcharge state, an overdischarge state, and a high temperature state, the storage battery controller 7 stops operation of the storage battery 3.

The fuel cell controller 8 detects a voltage and a current of the fuel cell 4, and calculates electric power to be generated. Further, the fuel cell controller 8 controls a voltage and a current of the fuel cell 4. The fuel cell controller 8 may be configured to control the above-described gas flow rate control valve or the like, to adjust supply amounts of fuel and air. Further, the fuel cell controller 8 may detect a temperature of the fuel cell 4. As a means for detecting the temperature, a temperature sensor or the like is used. The fuel cell controller 8 supplies electric power generated by the fuel cell 4 to the electric power load 101, and charges the storage battery 3 with an excess amount of electric power exceeding demand in the electric power load 101.

The electric power demand predictor 6 predicts the electric power demand E of the electric power load 101 in the future, and transmits a prediction result to the fuel cell controller 8. The electric power demand predictor 6 acquires a history of past electric power demand of the electric power load 101 via a communication line, for example, stores the history in the memory, and predicts, for example, demand of electric power for every one hour on the basis of the history of the past electric power demand. For example, the electric power demand predictor 6 predicts the electric power demand E of the electric power load 101 in the future on the basis of an average value of the past electric power demand in the past most recent week. In addition, the electric power demand predictor 6 may be configured to correct a predicted value of the electric power demand E on the basis of an average value of the electric power demand in the past most recent week on the basis of information such as season, weather, and a temperature.

The fuel cell controller 8 compares the electric power demand E predicted by the electric power demand predictor 6 with a fuel cell output F, and derives, as a first time t1, a time that is before a time at which the electric power demand E becomes maximum and is closest to the time at which the electric power demand E becomes maximum among times at which the electric power demand E and the fuel cell output F become equal to each other. As the fuel cell output F, a power generation output designated by a manufacturer of the fuel cell 4, for example, a rated output of the fuel cell 4 is adopted. The fuel cell controller 8 calculates a full-charge necessary electric power amount P for fully charging the storage battery 3 at the derived first time t1, and determines a fuel cell adjustment output Q by dividing the full-charge necessary electric power amount P by time from the present time to the first time t1.

Among the times at which the determined fuel cell adjustment output Q and the electric power demand E become equal to each other, the fuel cell controller 8 derives, as a second time t2, a time that is before a time at which the electric power demand E becomes maximum and is closest to the time at which the electric power demand E becomes maximum. The fuel cell controller 8 calculates a difference Δt between the first time t1 and the second time t2, and compares the calculated difference Δt with a threshold value Ta. When the difference Δt between both times exceeds the threshold value Ta, the fuel cell controller 8 recalculates the full-charge necessary electric power amount P and the fuel cell adjustment output Q by using the second time t2 instead of the first time t1. This is because the fuel cell output (the rated output) F and the adjusted fuel cell adjustment output Q are different from each other, and thus times at which each becomes equal to the electric power demand E are also different. When the first time t1 and the second time t2 are greatly different from each other, there is a possibility that the storage battery 3 is in a high charge state for a long time and the storage battery 3 deteriorates, or the storage battery 3 is not sufficiently charged. Therefore, the calculation of the fuel cell adjustment output Q is repeated until the difference Δt between both times falls within the threshold value Ta. When the difference Δt between both times falls within the threshold value Ta, the fuel cell 4 is controlled to generate electric power with the fuel cell adjustment output Q at that time.

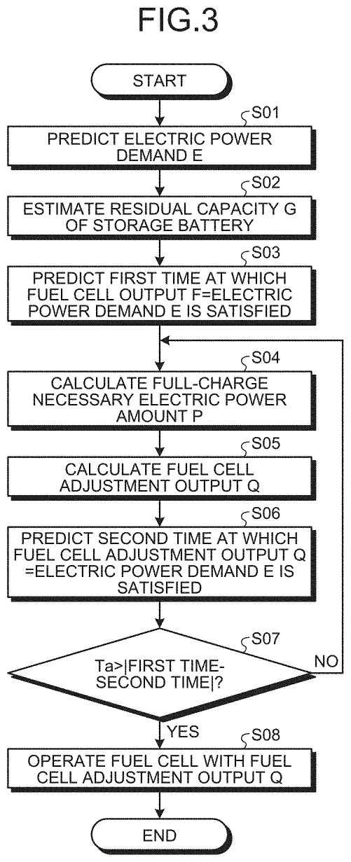

Next, an operation of the fuel cell system 1 of the first embodiment will be described with reference to FIG. 3. FIG. 3 is a flowchart illustrating a processing procedure example of the fuel cell system 1 of the first embodiment. First, the electric power demand predictor 6 predicts the electric power demand E in the future from a history of past electric power demand and the like, and transmits a prediction result to the fuel cell controller 8 (step S01).

Next, the storage battery controller 7 estimates the residual capacity G of the storage battery 3, and transmits the estimated residual capacity G of the storage battery 3 to the fuel cell controller 8 (step S02).

Next, the fuel cell controller 8 compares the electric power demand E predicted by the electric power demand predictor 6 with the fuel cell output (the rated output) F, and derives, as the first time t1, a time that is before a time at which the electric power demand E becomes maximum and is closest to the time at which the electric power demand E becomes maximum among times at which the electric power demand E and the fuel cell output F become equal to each other (step S03).

Next, the fuel cell controller 8 subtracts the present residual capacity G of the storage battery 3 from the full-charge capacity FCC of the storage battery 3, and adds a total of the electric power demand E from the present time to the first time t1, to calculate the full-charge necessary electric power amount P according to the following Equation (1) (step S04). In the following Equation (1), reference character “Dp” is electric power demand at each time, and reference character “t” is time. Reference character “∫Dpdt” is the total of the electric power demand E from the present time to the first time t1.

Full-charge necessary electric power amount P=FCC−residual capacity G+∫Dpdt (1)

Next, the fuel cell controller 8 calculates the fuel cell adjustment output Q by dividing the full-charge necessary electric power amount P by required time from the present time to the first time t1 (step S05). That is,

Fuel cell adjustment output Q=(the full-charge necessary electric power amount P)/(time required from present to the first time t1) is satisfied.

Next, the fuel cell controller 8 predicts, as the second time t2, a time that is before a time at which the electric power demand E becomes maximum and is closest to the time at which the electric power demand E becomes maximum among the times at which the fuel cell adjustment output Q and the electric power demand E become equal to each other (step S06).

Next, the fuel cell controller 8 calculates the difference Δt between the first time t1 and the second time t2, and compares the difference Δt with the threshold value Ta (step S07). When the difference Δt between both times exceeds the threshold value Ta (step S07: No), the calculation of the full-charge necessary electric power amount P (step S04), the calculation of the fuel cell adjustment output Q (step S05), and the prediction of the second time t2 (step S06) are repeated again using the second time t2 instead of the first time t1. Specifically, ∫Dpdt in Equation (1) is derived as the total of the electric power demand E from the present time to the second time t2. That is, the full-charge necessary electric power amount P is recalculated by obtaining a subtraction value obtained by subtracting the present residual capacity G of the storage battery 3 from the full-charge capacity FCC of the storage battery 3, and adding, to the subtraction value, the total of the electric power demand E from the present time to the second time t2. Then, by dividing the recalculated full-charge necessary electric power amount P by the required time from the present time to the second time t2, the fuel cell adjustment output Q is recalculated.

When the difference Δt between both times is within the threshold value Ta (step S07: Yes), the fuel cell controller 8 controls the fuel cell 4 to generate electric power with the fuel cell adjustment output Q (step S08). Supply amounts of fuel gas and oxygen may be adjusted according to an output of electric power to be generated.

When the electric power demand E>the fuel cell adjustment output is satisfied, the storage battery controller 7 discharges the storage battery 3, and supplies electric power of (the electric power demand−the fuel cell adjustment output) to the electric power load 101. When the electric power demand E<the fuel cell adjustment output is satisfied, the storage battery controller 7 charges the storage battery 3 with electric power of (the fuel cell adjustment output−the electric power demand).

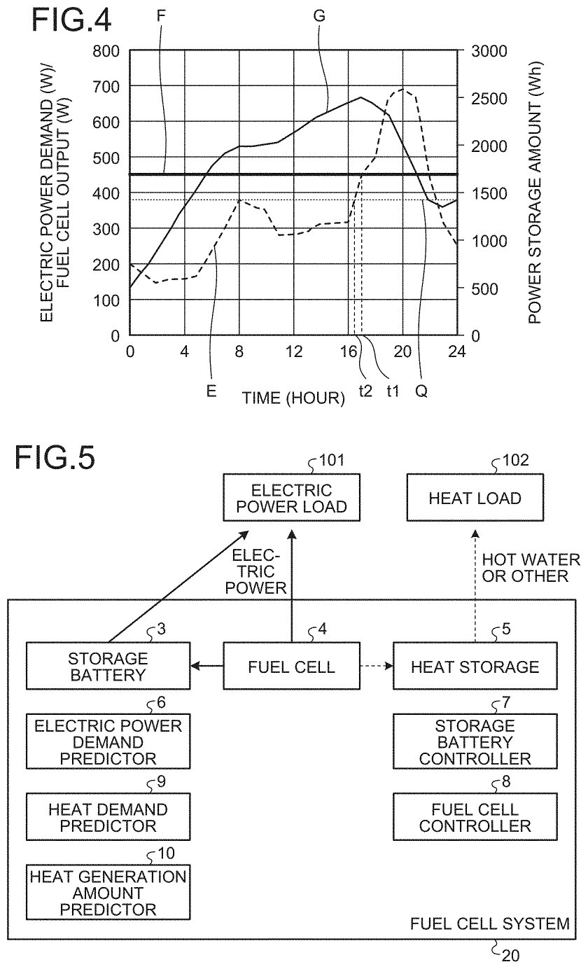

Next, with reference to FIG. 4, a specific operation example of the fuel cell system 1 installed in a home will be described. FIG. 4 is a graph illustrating daily temporal changes of the electric power demand E, the residual capacity G which is a storage amount of the storage battery 3, the fuel cell output F, and the fuel cell adjustment output Q. As the fuel cell output F, a rated output of the fuel cell 4 is used. First, the electric power demand predictor 6 reads out past power consumption for the past one week from a memory. The electric power demand predictor 6 calculates an average value of past power consumption for the past one week for every one hour up to 24 hours ahead, and sets the average value as the electric power demand E at each time. In FIG. 4, it is assumed that the present time is 0:00, and the electric power demand E of a general household as illustrated is predicted. In this electric power demand E, the electric power demand increases in the morning and evening, and the electric power demand becomes maximum at night. The electric power demand predictor 6 transmits a prediction result of the electric power demand E at each time to the fuel cell controller 8.

Next, the storage battery controller 7 estimates the residual capacity G of the storage battery 3. Here, it is assumed that the storage battery 3 having the correspondence table between a voltage and a state of charge (SOC) illustrated in FIG. 2 is adopted. When the voltage of the storage battery 3 is measured to be 3.46 V, the SOC of the storage battery 3 at that time is estimated to be 20% from the correspondence table. Further, in the case of FIG. 4, assuming that the full-charge capacity of the storage battery 3 is 2500 Wh, the residual capacity G when the SOC is 20% is calculated to be 500 Wh. The storage battery controller 7 transmits the estimated residual capacity G of the storage battery 3 to the fuel cell controller 8.

Next, the fuel cell controller 8 compares the electric power demand E predicted by the electric power demand predictor 6 with the fuel cell output F, and obtains, as the first time t1, a time that is before a time at which the electric power demand E becomes maximum and is closest to the time at which the electric power demand E becomes maximum among times at which the electric power demand E and the fuel cell output F become equal to each other. Here, since it is assumed that the fuel cell 4 having a rated output of 450 W is used, the fuel cell output F is 450 W. In FIG. 4, since the electric power demand E becomes the maximum at 20:00, 17:00 is immediately before the time at which the electric power demand E becomes the maximum among the times at which the electric power demand E and the fuel cell output F become equal to each other, and is to be the first time t1.

Next, the fuel cell controller 8 subtracts the present residual capacity G of the storage battery 3 from the full-charge capacity FCC of the storage battery 3, and adds a total of the electric power demand E from the present time to the first time t1, to calculate the full-charge necessary electric power amount P. The full-charge capacity is 2500 Wh, the residual capacity G at 0:00 time is 500 Wh, and the total of the electric power demand E until 17:00 is 4426 Wh. Therefore, the full-charge necessary electric power amount P is calculated to be 6426 Wh as in the following equation.

Full-charge necessary electric power amount P=2500 (Wh)−500 (Wh)+4426 (Wh)=6426 (Wh)

Next, the fuel cell controller 8 calculates the fuel cell adjustment output Q by dividing the full-charge necessary electric power amount P by required time from the present time to the first time t1. Since the present time is 0:00 and the first time is 17:00, the fuel cell adjustment output Q is calculated as 378 W as in the following equation.

Fuel cell adjustment output Q=6426 (Wh)/17 (h)=378 (W)

Next, the fuel cell controller 8 obtains, as the second time t2, a time that is before a time at which the electric power demand E becomes maximum and is closest to the time at which the electric power demand E becomes maximum among the times at which the fuel cell adjustment output Q and the electric power demand E become equal to each other. In the case of FIG. 4, the time between 16:00 and 17:00 is predicted to be the second time t2.

Next, the fuel cell controller 8 calculates the difference Δt between the first time t1 and the second time t2, and compares the calculated difference Δt with the threshold value Ta. Here, the threshold value Ta is, for example, one hour. Here, it is determined that the first time t1 is 17:00, the second time t2 is between 16:00 and 17:00, and the difference Δt is within one hour which is the threshold value Ta. Since the difference Δt between both the times is determined to be within the threshold value Ta, the fuel cell controller 8 controls the fuel cell 4 to generate electric power with an output of 378 W, which is the fuel cell adjustment output Q. When the fuel cell 4 is operated at 378 W which is the fuel cell adjustment output Q, a storage amount changes as illustrated in FIG. 4, and the storage battery 3 can be fully charged at the second time t2.

For example, when it is determined that the second time is before 16:00 and the difference Δt between both times exceeds the threshold value Ta, the full-charge necessary electric power amount P and the fuel cell adjustment output Q are recalculated using the second time t2 instead of the first time t1 (steps S04 and S05). Specifically, the full-charge necessary electric power amount P is recalculated by obtaining a subtraction value obtained by subtracting the present residual capacity G of the storage battery 3 from the full-charge capacity FCC of the storage battery 3, and adding, to the subtraction value, a total of the electric power demand E from the present time to the second time t2. Then, by dividing the recalculated full-charge necessary electric power amount P by the required time from the present time to the second time t2, the fuel cell adjustment output Q is recalculate.

As described above, in the first embodiment, since the storage battery 3 is controlled to be fully charged immediately before the electric power demand E becomes maximum, the time during which the storage battery 3 is in a high state of charge is minimized, and deterioration of the storage battery 3 can be suppressed. Further, since the fuel cell adjustment output Q is calculated by dividing the full-charge necessary electric power amount P by the required time from the present time to the first time t1 or the required time from the present time to the second time t2, a power generation output of the fuel cell 4 is constant, which makes it possible to suppress deterioration of the fuel cell 4 due to a large fluctuation in the output.

Note that, in the first embodiment, the processing in steps S06 and S07 can be eliminated, and the fuel cell 4 can be operated with the fuel cell adjustment output Q calculated in step S05.

### Second Embodiment

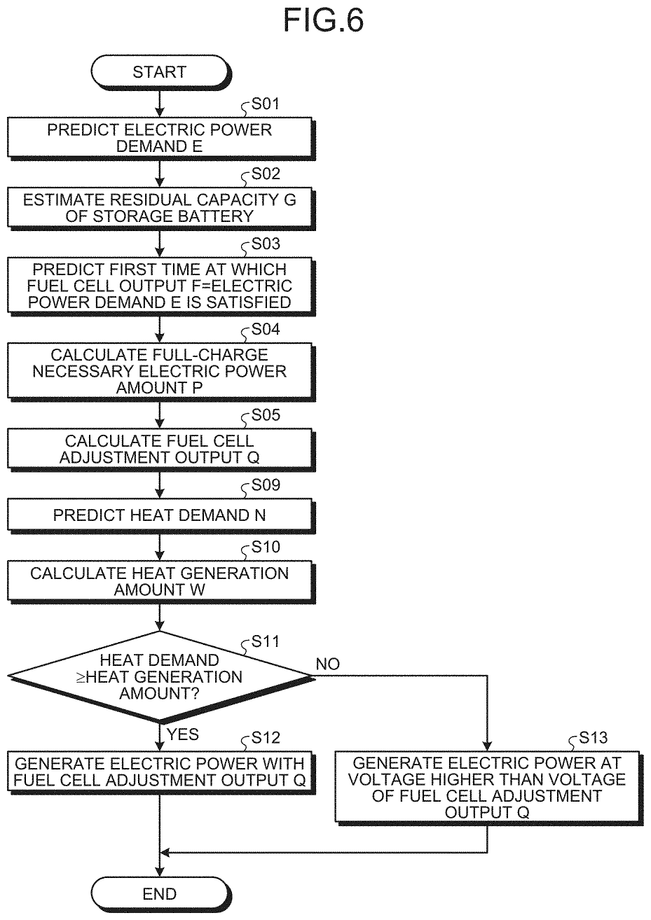

With reference to FIGS. 5 and 6, a fuel cell system 20 of the second embodiment will be described. FIG. 5 is a block diagram illustrating a functional configuration example of the fuel cell system 20 according to the second embodiment. The fuel cell system 20 includes the storage battery 3, the fuel cell 4, the heat storage 5, the electric power demand predictor 6, the storage battery controller 7, the fuel cell controller 8, a heat demand predictor 9, and a heat generation amount predictor 10, as main components. In the second embodiment, configurations and actions of the storage battery 3, the fuel cell 4, the heat storage 5, the electric power demand predictor 6, the storage battery controller 7, and the fuel cell controller 8 are basically similar to those of the first embodiment, and redundant descriptions will be omitted.

The heat demand predictor 9 predicts heat demand. N of the heat load 102 in the future, and transmits a total of the heat demand N to the fuel cell controller 8 as a heat demand prediction result. The heat demand predictor 9 acquires a history of past heat demand of the heat load 102 via a communication line, for example, stores the history in a memory, and predicts, for example, the heat demand N for every one hour on the basis of the history, of the past heat demand. The heat demand predictor 9 predicts the heat demand N on the basis of, for example, an average value of heat demand in the past most recent week. In addition, the heat demand predictor 9 may be configured to correct a prediction value of the heat demand N on the basis of an average value of the heat demand in the past most recent week on the basis of information such as season, weather, and a temperature.

The heat generation amount predictor 10 predicts a heat generation amount W by the fuel cell 4, and transmits a total heat generation amount to the fuel cell controller 8 as a heat generation amount prediction result. Examples of a means for predicting the heat generation amount by the fuel cell 4 include: a method of estimating from a history of a past heat generation amount; a method of having a table associating the heat generation amount with a temperature, a current, a voltage, a supply amount of fuel gas, a supply amount of air, and the like of the fuel cell 4 in advance; or the like.

Next, an operation of the fuel cell system 20 in the second embodiment will be described. FIG. 6 is a flowchart illustrating a processing procedure example of the fuel cell system 20 of the second embodiment. Processing similar to that in the flowchart illustrated in FIG. 3 is denoted by an identical step number.

First, the electric power demand predictor 6 predicts the electric power demand E in the future from a history of past electric power demand and the like, and transmits a prediction result to the fuel cell controller 8 (step S01).

Next, the storage battery controller 7 estimates the residual capacity G of the storage battery 3, and communicates the estimated residual capacity G of the storage battery 3 to the fuel cell controller 8 (step S02).

Next, the fuel cell controller 8 compares the electric power demand E predicted by the electric power demand predictor 6 with the fuel cell output F, and derives, as a first time t1, a time that is before a time at which the electric power demand E becomes maximum and is closest to the time at which the electric power demand E becomes maximum among times at which the electric power demand E and the fuel cell output F become equal to each other (step S03).

Next, the fuel cell controller 8 subtracts the present residual capacity G of the storage battery 3 from the full-charge capacity FCC of the, storage battery 3, and adds the total of the electric power demand E from the present time to the first time t1, to calculate the full-charge necessary electric power amount P according to Equation (1) (step S04).

Next, the fuel cell controller 8 calculates the fuel cell adjustment output Q by dividing the full-charge necessary electric power amount P by required time from the present time to the first time t1 (step S05).

Next, the heat demand predictor 9 predicts the heat demand N of the heat load 102 in the future, and notifies the fuel cell controller 8 of the predicted heat demand N (step S09).

Next, the heat generation amount predictor 10 predicts the heat generation amount W when the fuel cell 4 operates with the fuel cell adjustment output Q, and notifies the fuel cell controller 8 of the predicted heat generation amount W (step S10).

Next, the fuel cell controller 8 calculates a total of the heat demand N as a heat demand prediction result. The total of the heat demand N is a total of the heat demand N from the present time to a time that is after a time at which the heat demand N becomes maximum and is closest to the time at which the heat demand N becomes maximum, among times at which the heat demand N and the heat generation amount W become equal to each other. A total of the heat generation amount W is calculated as a heat generation amount prediction result. The total of the heat generation amount W is a total of the heat generation amount W from the present time to a time that is after a time at which the heat demand N becomes maximum and is closest to the time at which the heat demand N becomes maximum, among times at which the heat demand N and the heat generation amount W become equal to each other. The fuel cell controller 8 compares the prediction result of the heat demand N with the prediction result of the heat generation amount W (step S11). When the prediction result of the heat demand N≥the prediction result of the heat generation amount W is satisfied (step S11: Yes), the fuel cell controller 8 controls the fuel cell 4 to generate electric power with the fuel cell adjustment output Q (step S12). When the prediction result of the heat demand N<the prediction result of the heat generation amount W is satisfied (step S11: No), the fuel cell controller 8 controls the fuel cell 4 to generate electric power at a voltage (a current value is decreased) higher than a voltage of the fuel cell adjustment output Q (step S13).

According to the second embodiment, the following effects can be obtained in addition to the effects of the first embodiment. That is, when the prediction result of the heat demand N is smaller than the prediction result of the heat generation amount W, it is predicted that the heat will be excess. Therefore, by increasing the power generation voltage of the fuel cell 4 and decreasing the heat generation amount, an efficient operation can be performed.

### Third Embodiment

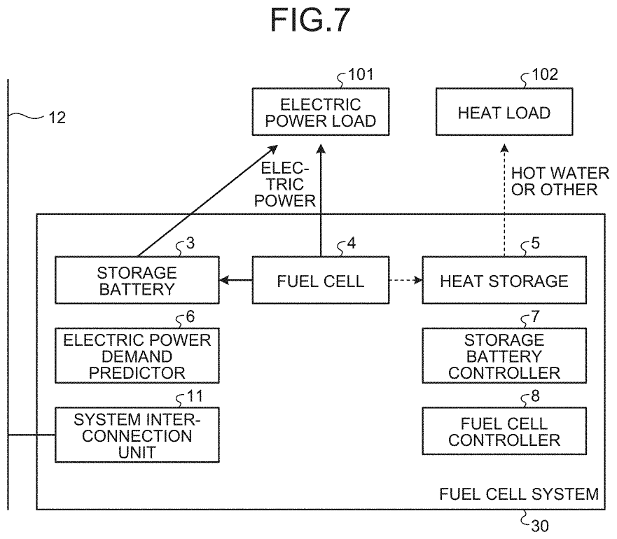

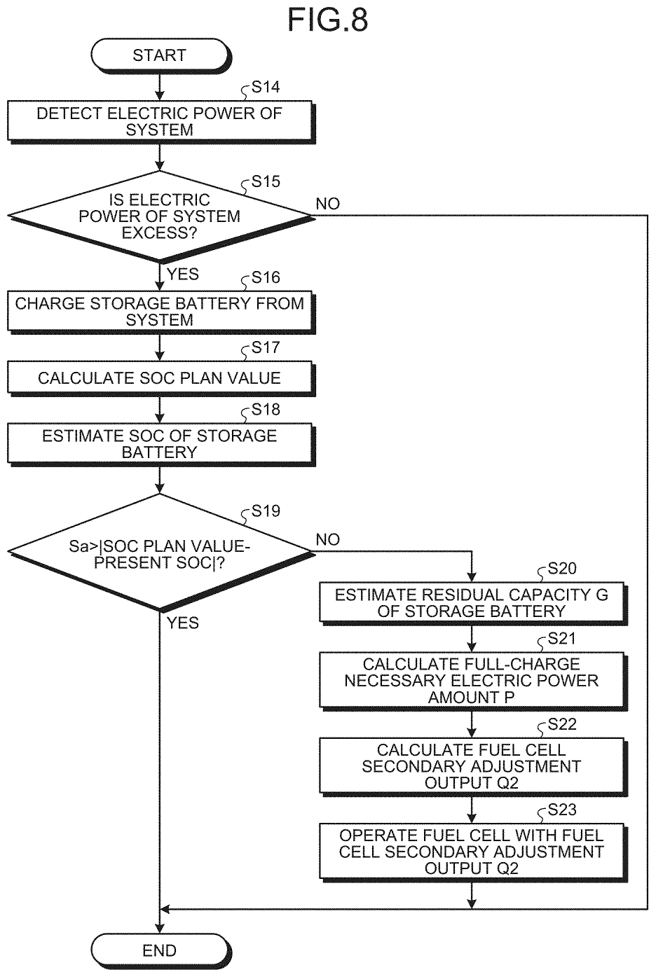

With reference to FIGS. 7 and 8, a fuel cell system 30 of a third embodiment will be described. FIG. 7 is a block diagram illustrating a functional configuration example of the fuel cell system 30 according to the third embodiment. The fuel cell system 30 according to the third embodiment includes the storage battery 3, the fuel cell 4, the heat storage 5, the electric power demand predictor 6, the storage battery controller 7, the fuel cell controller 8, and a system interconnector 11, as main components. In the third embodiment, configurations and actions of the storage battery 3, the fuel cell 4, the heat storage 5, and the electric power demand predictor 6 are basically similar to those of the first embodiment, and redundant descriptions will be omitted.

The system interconnector 11 is connected to a system 12, and monitors an electric power state of the system 12. Upon determining that electric power is excess in the system 12, the system interconnector 11 notifies the storage battery controller 7 of the excess electric power, and supplies electric power from the system 12 to the storage battery 3. Note that electric power information of the system 12 may be received from other than the system interconnector 11 via a communication line.

The storage battery controller 7 and the fuel cell controller 8 have the following functions in addition to the functions of the first embodiment. When the system interconnector 11 determines that electric power of the system 12 is excess, the storage battery controller 7 charges the storage battery 3 with electric power from the system 12 through the system interconnector 11. In addition, the storage battery controller 7 predicts, as a SOC plan value, a change in the SOC of the storage battery 3 when the fuel cell 4 generates electric power with the fuel cell adjustment output Q determined by the method described in the first embodiment. The storage battery controller 7 calculates a difference ΔS between the predicted SOC plan value and a present SOC, and compares the difference ΔS with a threshold value Sa. When the difference ΔS is within the threshold value Sa, an output of the fuel cell 4 is not to be changed. When the difference ΔS exceeds the threshold value Sa, the residual capacity G of the storage battery 3 is recalculated and notified to the fuel cell controller 8.

When the difference ΔS exceeds the threshold value Sa, the fuel cell controller 8 recalculates the full-charge necessary electric power amount P and a fuel cell secondary adjustment output Q2 by using the recalculated residual capacity G, and operates the fuel cell 4 with the calculated fuel cell secondary adjustment output Q2.

Next, an operation of the fuel cell system 30 in the third embodiment will be described. FIG. 8 is a flowchart illustrating a processing procedure example of the fuel cell system 30 of the third embodiment. It is assumed here that the flowchart of the first embodiment is completed, and that the fuel cell 4 is in a state of operating with the fuel cell adjustment output Q.

First, the system interconnector 11 monitors an electric power status of the system 12 (step S14). When the system interconnector 11 determines that electric power of the system 12 is excess (step S15: Yes), the system interconnector 11 supplies electric power from the system 12 to the storage battery 3. The storage battery controller 7 charges the storage battery 3 (step S16).

Next, the storage battery controller 7 predicts, as the SOC plan value, a change in the SOC of the storage battery 3 when the fuel cell 4 generates electric power with the fuel cell adjustment output Q determined by the method of the first embodiment (step S17).

Next, the storage battery controller 7 estimates a present SOC of the storage battery 3 (step S18).

Next, the storage battery controller 7 calculates the difference ΔS between the SOC plan value and the present SOC, and compares the difference ΔS with the threshold value Sa (step S19). When the difference ΔS is within the threshold value Sa (step S19: Yes), the output of the fuel cell 4 is not to be changed. When the difference ΔS exceeds the threshold value Sa (step S19: No), the storage battery controller 7 recalculates the residual capacity G of the storage battery 3, and notes the fuel cell controller 8 of the residual capacity G (step S20).

Next, similarly to the first embodiment, the fuel cell controller 8 recalculates the full-charge necessary electric power amount P, which is an electric power amount necessary for fully charging the storage battery 3, by using the recalculated residual capacity G. That is, the fuel cell controller 8 calculates the full-charge necessary electric power amount P by using the recalculated residual capacity G and the first time t1 or the second time t2. The first time t1 is to be selected in a case where the fuel cell adjustment output Q adopted in step S08 in FIG. 3 is calculated using the first time t1, and the second time t2 is to be selected in a case where the fuel cell adjustment output Q is calculated using the second time t2. The fuel cell controller 8 calculates the full-charge necessary electric power amount P according to Equation (1) by using the selected time among the first time t1 and the second time t2 and the recalculated residual capacity G (step S21). Further, the fuel cell controller 8 calculates the fuel cell secondary adjustment output Q2 by dividing the calculated full-charge necessary electric power amount P by required time from the present time to the time selected among the first time t1 and the second time and t2 (step S22).

Next, the fuel cell controller 8 controls the fuel cell 4 to generate electric power with the calculated fuel cell secondary adjustment output Q2 (step S23).

According to the third embodiment, the following effects can be obtained in addition to the effects of the first embodiment. That is, when electric power of the system 12 is excess, the storage battery 3 is charged with electric power supplied from the system 12, so that the system 12 can be stabilized. Further, when the difference ΔS between the originally planned SOC of the storage battery and the present SOC increases to be the threshold value Sa or more, the fuel cell 4 is operated with the recalculated fuel cell secondary adjustment output Q2, so that the storage battery 3 can accurately be fully charged immediately before the electric power demand becomes maximum. Therefore, the time during which the storage battery 3 is in a high charge state is minimized, and deterioration of the storage battery 3 can be suppressed. In addition, the power generation output of the fuel cell 4 is constant, which makes it possible to suppress deterioration due to a large fluctuation in the output.

The configuration illustrated in the above embodiment illustrates one example of the contents of the present disclosure and can be combined with another known technique, and it is also possible to omit and change a part of the configuration without departing from the subject matter of the present disclosure.

### REFERENCE SIGNS LIST

1, 20, 30 fuel cell system; 3 storage battery; 4 fuel cell; 5 heat storage; 6 electric power demand predictor; 7 storage battery controller; 8 fuel cell controller; 9 heat demand predictor; 10 heat generation amount predictor; 11 system interconnector; 12 system; 101 electric power load; 102 heat load.

1. A fuel cell system comprising:
a fuel cell;
a storage battery adapted to store electric power generated by the fuel cell and supply electric power to an electric power load;
a storage battery controller adapted to control charging and discharging of the storage battery and acquire a residual capacity of the storage battery;
an electric power demand predictor adapted to predict electric power demand of the electric power load; and
a fuel cell controller adapted:
to calculate a full-charge necessary electric power amount that is an electric power amount necessary for fully charging the storage battery by using
a first time being a time that is before a time at which electric power demand becomes maximum and is closest to the time at which electric power demand becomes maximum among times at which the predicted electric power demand and a fuel cell output become equal to each other; and
the acquired residual capacity; and
to calculate a fuel cell adjustment output by dividing the calculated full-charge necessary electric power amount by time from a present time to the first time; and
to control the fuel cell to cause the fuel cell to generate electric power with the calculated fuel cell adjustment output.

2. The fuel cell system according to claim 1, wherein
the fuel cell controller is adapted to calculate the full-charge necessary electric power amount, by
obtaining a subtraction value obtained by subtracting the residual capacity of the storage battery from a full-charge capacity of the storage battery; and
adding, to the subtraction value, total electric power demand from a present time to the first time.

3. The fuel cell system according to claim 2, wherein
the fuel cell controller is adapted to:
obtain a second time, the second time being a time that is before a time at which electric power demand becomes maximum and is closest to the time at which electric power demand becomes maximum among times at which the fuel cell adjustment output and the predicted electric power demand become equal to each other;
obtain a difference between the first time and the second time; and
control the fuel cell to cause the fuel cell to generate electric power with the fuel cell adjustment output when the difference is smaller than a first threshold value.

4. The fuel cell system according to claim 3, wherein
the fuel cell controller is adapted to:
calculate a full-charge necessary electric power amount that is an electric power amount necessary for fully charging the storage battery, by using the second time and the acquired residual capacity when the difference is larger than the first threshold value;
calculate a fuel cell adjustment output by dividing the calculated full-charge necessary electric power amount by time from a present time to the second time; and
control the fuel cell to cause the fuel cell to generate electric power with the calculated fuel cell adjustment output.

5. The fuel cell system according to claim 4, wherein
the fuel cell controller is adapted to calculate the full-charge necessary electric power amount by:
obtaining a subtraction value obtained by subtracting the residual capacity of the storage battery from a full-charge capacity of the storage battery; and
adding, to the subtraction value, total electric power demand from a present time to the second time.

6. The fuel cell system according to claim 1, wherein the fuel cell output is a rated output of the fuel cell.

7. The fuel cell system according to claim 1, further comprising:
a heat storage adapted to store heat generated by the fuel cell, and supply heat to a heat load;
a heat demand predictor adapted to predict heat demand in the heat load; and
a heat generation amount predictor adapted to predict a heat generation amount of the fuel cell, wherein
the heat generation amount predictor is adapted to calculate a heat generation amount of the fuel cell when electric power is generated with the fuel cell adjustment output; and
the fuel cell controller is adapted to control the fuel cell to cause the fuel cell to:
generate electric power with the fuel cell adjustment output in a case where a total of the calculated heat generation amount from a present time to a time that is after a time at which the heat demand becomes maximum and is closest to the time at which the heat demand becomes maximum among times at which the heat demand and the heat generation amount become equal to each other is equal to or less than a total of the predicted heat demand from a present time to a time that is after a time at which the heat demand becomes maximum and is closest to the time at which the heat demand becomes maximum among times at which the heat demand and the heat generation amount become equal to each other; and
generate electric power at a voltage higher than a voltage of the fuel cell adjustment output in a case where the total of the calculated heat generation amount is larger than the total of the predicted heat demand.

8. The fuel cell system according to claim 7, wherein
the electric power demand predictor is adapted to predict future electric power demand of the electric power load based on a history of past electric power demand of the electric power load; and
the heat demand predictor is adapted to predict future heat demand of the heat load based on a history of past heat demand of the heat load.

9. The fuel cell system according to claim 5, further comprising:
a system interconnector adapted to interconnect with a system, wherein
the storage battery controller is adapted to charge the storage battery from the system via the system interconnector when electric power becomes excess in the system.

10. The fuel cell system according to claim 9, wherein the fuel cell controller is adapted to:
predict a residual state of the fuel cell when the fuel cell controller controls the fuel cell to cause the fuel cell to generate electric power with the fuel cell adjustment output;
reacquire a residual capacity of the storage battery when a residual state of the fuel cell is separated from the predicted residual state by a second threshold value or more;
recalculate a full-charge necessary electric power amount that is an electric power amount necessary for fully charging the storage battery, by using the reacquired residual capacity of the storage battery and the first time or the second time;
recalculate a fuel cell adjustment output by dividing the calculated full-charge necessary electric power amount by time from a present time to the first time or the second time; and
control the fuel cell to cause the fuel cell to generate electric power with the calculated fuel cell adjustment output.

11. A control method for a fuel cell system, the fuel cell system including a fuel cell and a storage battery to store electric power generated by the fuel cell and supply electric power to an electric power load, the method comprising:
acquiring a residual capacity of the storage battery;
predicting electric power demand of the electric power load; and
controlling the fuel cell to cause the fuel cell to generate electric power with the calculated fuel cell adjustment output by:
calculating a full-charge necessary electric power amount that is an electric power amount necessary for fully charging the storage battery by using a first time and the acquired residual capacity; and
calculating a fuel cell adjustment output by dividing the calculated full-charge necessary electric power amount by time from a present time to the first time, wherein
the first time is a time that is before a time at which electric power demand becomes maximum and is closest to the time at which electric power demand becomes maximum among times at which the predicted electric power demand and a fuel cell output become equal to each other.

12. The fuel cell system according to claim 2, wherein the fuel cell output is a rated output of the fuel cell.

13. The fuel cell system according to claim 3, wherein the fuel cell output is a rated output of the fuel cell.

14. The fuel cell system according to claim 4, wherein the fuel cell output is a rated output of the fuel cell.

15. The fuel cell system according to claim 5, wherein the fuel cell output is a rated output of the fuel cell.
